(19) United States
(12) Patent Application Publication
(10) Pub. No.: US 2026/0209468 A1
(43) Pub. Date: Jul. 23, 2026

(54) Polymer-Graphene Composite Material, Assembly for Hydrogen Storage and/or Transport, and Hydrogen Carrier

(71) Applicant: GraphMaTech AB, Uppsala (SE)

(72) Inventors: Taher Mamoun, Uppsala (SE); Guillaume Ratouit, Uppsala (SE)

(21) Appl. No.: 19/141,566

(22) PCT Filed: Dec. 22, 2023
(86) PCT No.: PCT/EP2023/087777

§ 371 Date: Jun. 20, 2025

(30) Foreign Application Priority Data
Dec. 22, 2022 (WO) PCT/EP2022/087474
Dec. 22, 2022 (WO) PCT/EP2022/087476

(51) Int. Cl. C08K 3/04; C08K 3/34; C08K 5/55; F17C 1/16

(52) U.S. Cl. CPC C08K 3/042; C08K 3/346; C08K 5/55; F17C 1/16; C08K 2201/011; F17C 2201/0104; F17C 2203/0604; F17C 2203/0619; F17C 2203/0643; F17C 2203/066; F17C 2203/0673; F17C 2203/0675; F17C 2209/2127; F17C 2221/012

(57) ABSTRACT

A polymer-based composite material and an assembly for hydrogen storage and/or transport including a hollow body and at least one hydrogen barrier lining arranged on the body. The at least one hydrogen barrier lining includes the polymer-based composite material. A method for manufacturing the assembly for hydrogen storage and/or transport includes lining an inner surface of the assembly with one of the at least one hydrogen barrier linings.

### CROSS-REFERENCE TO RELATED APPLICATIONS

This application is the United States national phase of International Patent Application No. PCT/EP2023/087777 filed Dec. 22, 2023, and claims priority to International Patent Application Nos. PCT/EP2022/087474 and PCT/EP2022/087476 filed Dec. 22, 2022, the disclosures of which are hereby incorporated by reference in their entireties.

### BACKGROUND OF THE INVENTION

### Field of the Invention

The present patent disclosure is within in the field of hydrogen transport and storage and polymer-based materials for such transport and storage. Particular embodiments concern a polymer-based composite material, an assembly for hydrogen storage and/or transport, a method for manufacturing such assemblies and use of the polymer-based composite material.

### Description of Related Art

In recent years there has been an increased interest in the use of hydrogen as in fuel cells to create electrical energy. Provided that the green hydrogen is created in a process that does not produce carbon dioxide it can be regarded as a zero-carbon electricity source.

For hydrogen to reach its full potential as a clean energy source, however, the hydrogen will need to be transported to where it is to be used, which could be far away. For example, hydrogen may have to be transported from hydrogen production sites to factories, or inside different vehicles such as cars, trucks and buses where hydrogen can be used as a source of fuel. Due to its small size, it is challenging to transport hydrogen, both in its liquid and gaseous state. It is highly permeating and therefore hard to enclose.

In recent years numerous reports have discussed the problem with increased amounts of hydrogen in the air. It has been discussed that hydrogen in the air affects other substances such as methane, ozone and water vapour. This results in hydrogen to be considered an indirect greenhouse gas with an estimated global warming potential of 5.8 over a 100-year time horizon. Therefore, hydrogen leakage into the atmosphere is unwanted and is a potential risk for the hydrogen economy.

For hydrogen storage, different types of vessels are used, such as Type III and Type IV vessels. Type IV pressure vessels are containers made from carbon/glass fiber with polymer liner material whereas Type III pressure vessels are metal based. The vessels operate at pressures between 300 bar and 750 bar. For transport, different type of piping is used, such as metal based or polymer-based piping. A polymer lining can also be added to existing metal-based piping to improve permeation properties and chemical resistance of the pipe. Polymer based piping are known to be less exposed to corrosion than metal pipes, which normally are steel based. The polymer provides fatigue resistance, low cost, and high durability, but also high H₂ permeability compared to Type III pressure vessels or metal piping. It is therefore a need to improve permeability of existing polymers for storage and transport of hydrogen.

Commonly used polymers for hydrogen storage and transport are polyolefins and polyamides. Polyolefins, such as polyethylene, display both some advantages and some less beneficial properties as compared to polyamides when used as materials for hydrogen storage and transportation. One disadvantage of polyolefins is that permeability of hydrogen is about one order of magnitude higher than that of polyamides. Therefore, polyolefins are normally used for storage and transportation at lower pressures, such as storage of hydrogen gas at up to around 350 Bar, whereas polyamides are used at higher pressures up to 700 Bars. Polyolefins, such as High-Density Polyethylene (HDPE), are, however, easier to process than polyamides, where the latter experience several limitations such as high crystallization rate, too high melt flow rate and degradation due to moisture uptake. On the other hand, polyamides have better mechanical properties compared to polyolefins, such as higher ultimate strength but also tend to be more brittle leading to decreased elongation at break and reduced impact strength.

US 2022/0003362 according to its abstract states that a plant for delivering hydrogen includes a hydrogen tank and at least one pipe for delivering hydrogen. At least one surface of the hydrogen tank or the hydrogen delivery pipe is covered with a two-dimensional material mixed with a polydopamine-type polymer.

### SUMMARY OF THE INVENTION

It is an object, among objects, to provide improved assemblies for hydrogen storage and/or transport. It is also an object, among objects, to provide improved materials that can be used in assemblies for hydrogen storage and/or transport.

To this end, there is provided a polymer-based composite material comprising a polyethylene-based polymer matrix and reduced graphene oxide in an amount of 1.2%-15% in weight per weight of the polyethylene-based polymer matrix, wherein the polyethylene-based polymer matrix is a high density polyethylene-based polymer matrix.

The provided polymer-based composite material comprising reduced graphene oxide shows a reduced hydrogen permeability compared to bare polyethylene-based polymer, such as HDPE and increased ultimate strength while maintaining elongation at break on the same level as the HDPE without reduced graphene oxide. The obtained experimental results for composite materials falling within this scope described below and in FIG. 3 show a clear trend of decreasing hydrogen permeability the more reduced graphene oxide is in the composite material. At the same time, at the above noted reduced graphene oxide concentration range of 0.1 wt % to 15 wt % relative to the polyethylene-based polymer matrix, the composite material can be processed using standard polymer processing techniques, such as injection moulding, rotational moulding, compression moulding, blow moulding and/or extrusion. At concentrations of reduced graphene oxide above 15 wt %, the composite material becomes relatively cumbersome to process, even though the hydrogen permeability would be lower than for lower concentrations of reduced graphene oxide in the composite material.

The presence of the reduced graphene oxide in the composite material has the additional benefit that the composite material becomes more electrically conductive than the bare polyethylene-based polymer matrix without reduced graphene oxide present. As mixtures of hydrogen with air have a relatively low ignition energy, electrical discharge can be a problem when storing and transporting hydrogen. In applications where the composite material is in contact with hydrogen, the safety is improved, as there is a lowered chance of electrical discharges from static electricity built-up on the polyethylene-based polymer.

In an embodiment, the reduced graphene oxide is distributed and/or dispersed in the polyethylene-based polymer matrix. The reduced graphene oxide is preferably homogeneously distributed and/or dispersed in the polyethylene-based polymer matrix. Advantageously, distributed and/or dispersed reduced graphene oxide is beneficial in terms of gas permeability, such as hydrogen gas permeability.

In an embodiment, the polymer-based composite material comprises the reduced graphene oxide in an amount of 0.5%-9% in weight per weight of the polyethylene-based polymer matrix. This range results in a composite material having an advantageous combination of lowered hydrogen permeability and processability of the composite material using the standard polymer processing techniques.

In an embodiment, the amount of reduced graphene oxide in the polymer-based composite material is 0.5%-5% in weight per weight of the polyethylene-based polymer matrix. This range results in a composite material having an even more advantageous combination of lowered hydrogen permeability and processability of the composite material using the standard polymer processing techniques.

In an embodiment, the amount of reduced graphene oxide in the polymer-based composite material is 2.5%-5% in weight per weight of the polyethylene-based polymer matrix.

In an embodiment, the amount of reduced graphene oxide in the polymer-based composite material is 3%-5% in weight per weight of the polyethylene-based polymer matrix.

In an embodiment, the amount of reduced graphene oxide in the polymer-based composite material is 3.4%-5%, preferably 3.8%-5%, in weight per weight of the polyethylene-based polymer matrix. These concentration ranges of reduced graphene oxide particularly have a combination of reduced hydrogen permeability and reduced electrical resistivity.

In an embodiment, the polymer-based composite material comprises reduced graphene oxide in an amount of 2%-9% in weight per weight of the polyethylene-based polymer matrix.

In an embodiment, the amount of reduced graphene oxide in the polymer-based composite material is 2%-7% in weight per weight of the polyethylene-based polymer matrix.

In an embodiment, the amount of reduced graphene oxide in the polymer-based composite material is 2.3%-7% in weight per weight of the polyethylene-based polymer matrix, preferably 2.3%-5% in weight per weight of the polyethylene-based polymer matrix, such as 2.5%-5%, and 3%-5% in weight per weight of the polyethylene-based polymer matrix.

In an embodiment, the polymer based composite material has a hydrogen permeability as measured according to ASTM D1434-82, procedure M, that is reduced by at least 15%, preferably at least 20%, more preferably at least 30% compared to neat high-density polyethylene.

In an embodiment, the polyethylene-based polymer matrix is based upon an extrusion grade high-density polyethylene, and the polymer based composite material has a hydrogen permeability as measured according to ASTM D1434-82, procedure M, that is reduced by at least 13%, preferably at least 17%, more preferably at least 47% compared to neat high-density polyethylene.

In an embodiment, the polyethylene-based polymer matrix is based upon an injection-moulding grade high-density polyethylene, and the polymer based composite material has a hydrogen permeability as measured according to ASTM D1434-82, procedure M, that is reduced by at least 28%, preferably at least 56%, more preferably at least 63% compared to neat high-density polyethylene.

In an embodiment, the polymer based composite material has an elongation at break as measured according to ISO 527:2019 at 23° C. that is similar to, or on average equal to, neat high-density polyethylene.

In an embodiment, the polymer based composite material has an ultimate strength as measured according to ISO 527:2019 at 23° C. that is increased by at least 10%, preferably 12%, compared to neat high-density polyethylene.

In an embodiment, the polymer-based composite material further comprises nanoclay.

In an embodiment, the polymer-based composite material comprises the nanoclay in an amount equal to 90 to 110 wt % per weight of reduced graphene oxide.

In an embodiment, the nanoclay comprises, or consists of, layered mineral silicate-based nanoparticles.

In an embodiment, the layered mineral silicate-based nanoparticles comprise one or more selected from the group consisting of montmorillonite nanoparticles, bentonite nanoparticles, kaolinite nanoparticles, hectorite nanoparticles, halloysite nanoparticles.

In an embodiment, the reduced graphene oxide in the polymer-based composite material comprises a Li-salt. Results on hydrogen permeability show an even lower hydrogen permeability for the polymer-based composite materials comprising reduced graphene oxide and the Li-salt.

In an embodiment, the polymer-based composite material comprises the Li-salt in a concentration of 1 to 50 wt %, preferably 2 to 30 wt %, more preferably 5 to 20 wt %, per weight of reduced graphene oxide.

In an embodiment, the Li-salt is lithium bis(salicylate) borate. In an embodiment, the polymer-based composite material comprises the lithium bis(salicylate) borate in an amount in the range of 2 to 50 wt %, preferably 5 to 30 wt %, more preferably 7 to 20 wt %, per weight of reduced graphene oxide. The exact amount of added Li-salt, such as the lithium bis(salicylate) borate, is not important. The addition of the Li-salt within the indicated ranges beneficially improves the dispersion and/or interaction of the rGO with the polymer.

In an embodiment, the polymer-based composite material comprises the Li-salt in the range of 1-50 wt % relative to the reduced graphene oxide, preferably 4-20 wt %, more preferably 6-15 wt %, for instance 7 wt %, 8 wt %, 9 wt %, 10 wt %, 11 wt %, 12 wt %, 13 wt %, or 14 wt % relative to the reduced graphene oxide.

In an embodiment, the polyethylene-based polymer matrix is a high-density polyethylene-based polymer matrix. One advantage of the use of high-density polyethylene (HDPE) is that it is known to be suitable for hydrogen applications, such as for hydrogen transport pipes.

The HDPE may have an average molecular weight in the range of 50,000 to 300,000 Da, such as 100,000 to 250,000 Da. The HDPE may have a melt flow rate in the range of 0.01 to 5 g/10 min, for instance 0.1 to 4 g/10 min or 0.5 to 2 g/10 min, as determined according to ISO1133 at 190° C. with an applied weight of 2.16 kg. As is well known in the field of polymer processing, different techniques of manufacturing parts using HDPE typically work best with HDPE different melt flow rates, respectively. For instance, HDPE having melt flow rates in the lower end of the mentioned ranges, such as 0.1 to 1 g/10 min, may be more suitable for techniques where a higher viscosity is preferred, such as extrusion, while, for instance, HDPE in the higher end of the mentioned ranges, such as 1 to 4 g/10 min, may be more suitable for other techniques where are lower viscosity is preferred, such as injection moulding. The polymer-based composite material according to the present patent disclosure shows the beneficial effects, such as that of a reduced hydrogen permeation compared to bare HDPE, for HDPE in general, including HDPE with the melt flow rates mentioned above.

The polymer-based composite material as described herein, wherein the reduced graphene oxide comprises oxygen in the range of 0.1 to 50 wt %.

According to a second aspect, there is provided an assembly for hydrogen storage and/or transport, the assembly comprising:
a hollow body; and
at least one hydrogen barrier lining arranged along a surface of the hollow body;
   wherein the at least one hydrogen barrier lining comprises a polymer-based composite material comprising a polyethylene-based polymer matrix and reduced graphene oxide in an amount of 0.1%-15% in weight per weight of the polyethylene-based polymer matrix.

The provided assembly for hydrogen storage and/or transport comprises the polymer-based composite material according to the first aspect which shows a reduced hydrogen permeability compared to the bare polyethylene-based polymer. The hollow body being provided with the hydrogen barrier lining made from the polymer-based composite material thus reduced the hydrogen leakage towards the surface of the hollow body at which the lining is provided. Thereby also, the driving force for hydrogen to permeate into or through the hollow body is reduced. For instance, if the hollow body is made of a polymer material, such as HDPE, the hydrogen permeation through the hollow body is reduced. If the hollow body is made of, for instance, steel, then the rate of hydrogen embrittlement is reduced.

The assembly may be a hydrogen carrying assembly. The assembly may additionally or alternatively be referred to as a hydrogen transport and/or storage assembly.

The lining can additionally provide a pathway for conducting electricity and thus reduces the chance of discharges towards a hydrogen rich environment when the assembly is in use.

In an embodiment, the surface of the hollow body is an inner surface of the hollow body.

In an embodiment, the hollow body is a tank, a vessel, a pipe, a joint, or a cylinder.

In an embodiment, the assembly is a hydrogen storage container or a hydrogen transport container, In an embodiment, the hydrogen storage container is a hydrogen storage tank, a hydrogen storage vessel, or a hydrogen cylinder.

In an embodiment, the hydrogen barrier lining is a hydrogen gas barrier lining.

In an embodiment, the hydrogen cylinder is a hydrogen gas cylinder.

In an embodiment, the hydrogen transport container is a hydrogen transport pipe or a joint for joining hydrogen transport pipes.

In an embodiment, the hollow body is a hollow stainless-steel body, a hollow carbon fibre winded body, or a hollow polymer body.

In an embodiment, the hydrogen barrier lining is attached to the hollow body using an adhesive.

Alternatively, the hydrogen barrier lining is attached to the hollow body in a binder-free manner.

In an embodiment, the hydrogen barrier lining is a blow moulded hydrogen barrier lining.

In an embodiment, the polymer-based composite material is the polymer-based composite material according to any embodiment of the first aspect and/or any embodiment described below.

According to a third aspect, there is provided a method for manufacturing an assembly for hydrogen storage and/or transport, the assembly comprising a hollow body and at least one hydrogen barrier lining, the method comprising lining a surface of the hollow body with one of the at least one hydrogen barrier linings.

In an embodiment, the surface of the hollow body lined with the hydrogen barrier lining is an inner surface of the hollow body.

In an embodiment, the lining of the surface of the hollow body is done using blow moulding.

In an embodiment, the assembly for hydrogen storage and/or transport is the assembly for hydrogen storage and/or transport according to any embodiment of the second aspect and/or any embodiment described below.

According to a fourth aspect, there is provided use of a polymer-based composite material according to any embodiment of the first aspect as a hydrogen barrier lining.

### Hydrogen Carrier

Hydrogen carriers, such as hydrogen storage containers and hydrogen transport pipes, can be used to store and/or transport hydrogen, for instance as liquid hydrogen or pressurized gaseous hydrogen gas.

It is another object, among objects, to provide improved hydrogen carriers for hydrogen storage and/or transport. It is also an object, among objects, to provide improved materials that can be used in hydrogen carriers for hydrogen storage and/or transport.

To this end, in a fifth aspect, there is provided a hydrogen carrier for hydrogen storage and/or transport, the hydrogen carrier comprising—a hollow body comprising a polymer-based graphene composite material comprising a polyethylene-based polymer matrix and reduced graphene oxide in an amount of 0.1%-15% in weight per weight of the polyethylene-based polymer matrix.

The hollow body may be made of the polymer-based graphene composite material.

The provided hydrogen carrier for hydrogen storage and/or transport comprises the polymer-based composite material according to the first aspect which shows a reduced hydrogen permeability compared to the bare polyethylene-based polymer. The hollow body being comprised of the polymer-based composite material thus reduced the hydrogen leakage towards the outer surface of the hollow body.

The hydrogen carrier may additionally or alternatively be referred to as a hydrogen transport carrier and/or hydrogen storage carrier.

The hollow body can additionally provide a pathway for conducting electricity and thus reduces the chance of discharges towards a hydrogen rich environment when the assembly is in use.

In an embodiment, the hollow body is made of the polymer-based graphene composite material.

In an embodiment, the hollow body is a tank, a vessel, a pipe, a joint, or a cylinder.

In an embodiment, the hydrogen carrier is a hydrogen storage container or a hydrogen transport carrier, In an embodiment, the hydrogen storage container is a hydrogen storage tank, a hydrogen storage vessel, or a hydrogen cylinder.

In an embodiment, the hydrogen cylinder is a hydrogen gas cylinder.

In an embodiment, the hydrogen transport carrier is a hydrogen transport pipe or a joint for joining hydrogen transport pipes.

In an embodiment, the polymer-based composite material is the polymer-based composite material according to any embodiment of the first aspect and/or any embodiment described below.

In an embodiment, the hollow body is a first hollow body; and the hydrogen carrier further comprises a second hollow body concentrically arranged relative to the first hollow body.

In an embodiment, the second hollow body is a hollow mechanical reinforcement body.

In an embodiment, the hydrogen carrier may further comprise a third hollow body arranged in between the first hollow body and the second hollow body.

In an embodiment, at least one of the second and third hollow bodies is a hollow mechanical reinforcement body.

Any of the additional hollow bodies may add mechanical strength and/or stability to the hydrogen carrier. For instance, the hydrogen carrier may have to withstand conditions during pipe laying and also during use with, for instance, high pressure hydrogen gas.

In an embodiment, the second hollow body is made of the polymer-based composite material.

In an embodiment, the second hollow body is arranged inside the first hollow body.

In an alternative embodiment, the first hollow body is arranged inside the second hollow body.

According to a sixth aspect, there is provided a method for manufacturing a hydrogen carrier according wherein the hydrogen carrier is manufactured using extrusion or injection moulding.

In an embodiment, the hydrogen carrier for hydrogen storage and/or transport is the hydrogen carrier for hydrogen storage and/or transport according to any embodiment of the fifth aspect and/or any embodiment described below.

According to a seventh aspect, there is provided an extruded hydrogen carrier comprising or consisting of a polymer-based composite material comprising a polyethylene-based polymer matrix and reduced graphene oxide in an amount of 0.1%-15% in weight per weight of the polyethylene-based polymer matrix.

In an embodiment, the polymer-based composite material is the polymer-based composite material according to any embodiment of the first aspect and/or any embodiment described below.

It will be understood that technical advantages and effects associated with features and/or embodiments of one aspect, apply to the corresponding, similar or equivalent features and/or embodiments the other aspects. It will also be apparent that the features of the various aspects and/or embodiments thereof may be applied to the other aspects and/or embodiments thereof.

### BRIEF DESCRIPTION OF THE DRAWINGS

The terms Fig., Figs., Figure, and Figures are used interchangeably in the specification to refer to the corresponding figures in the drawings.

The accompanying drawings are used to illustrate presently preferred non-limiting exemplary embodiments of devices of the present disclosure. The above and other advantages of the features and objects of the disclosure will become more apparent, and the aspects and embodiments will be better understood from the following detailed description when read in conjunction with the accompanying drawings, in which:

FIG. 1a is a schematic drawing of an embodiment of the assembly according to the present patent disclosure;

FIG. 1b is a schematic drawing of another embodiment of the assembly according to the present patent disclosure;

FIG. 1c is a schematic drawing of an embodiment of the assembly according to the present patent disclosure;

FIG. 1d is a schematic drawing of an embodiment of the assembly according to the present patent disclosure;

FIG. 2 is a schematic drawing of one embodiment of the polymer-based composite material of the present patent disclosure;

FIG. 3 is a graph of H₂ permeability [mol·m⁻¹·s⁻¹·MPa⁻¹] as a function of reduced graphene oxide concentration [wt %] in different polymer-based composite materials of the present patent disclosure;

FIG. 4 is a graph of volume resistivity [ohm·cm] as a function of reduced graphene oxide concentration [wt %] in different polymer-based composite materials of the present patent disclosure;

FIG. 5a-d are schematic drawings of respective embodiments of the hydrogen carrier according to the present patent disclosure; and

FIG. 6 is a graph of H₂ permeability [mol·m⁻¹·s⁻¹·MPa⁻¹] as a function of reduced graphene oxide concentration [wt %] in different polymer-based composite materials of the present patent disclosure.

### ABBREVIATIONS

GO—graphene oxide;
HDPE—high density polyethylene;
LB—lithium bis(salicylate) borate;
NC—nanoclay;
rGO—reduced graphene oxide;
PE—polyethylene.

### DESCRIPTION OF THE INVENTION

Assemblies for carrying or being in contact with hydrogen, such as storage containers and transport pipes and pipe joints, such as tanks, vessels, cylinders, etc. have requirements in terms of thermal endurance, mechanical strength, and gas permeability. Examples of storage containers include tanks, vessels, cylinders, cartridges, canisters, cages, and caves. Assemblies for hydrogen storage and/or transport as used herein can be open- or close-ended, it can also be open at one end but closed at the other.

Graphene is a 2-dimensional carbon material. Graphene is a layered material in the form of flakes or sheets. Graphene comprises at least 30 at % carbon, has a hexagonal lattice and a thickness 1-20 times the size of a carbon atom. In the present patent disclosure, reduced graphene oxide (rGO) is used in the composite materials.

In one embodiment of the present patent disclosure the composite material comprises salts, such as Li-salts, or Li-borate salts. In one embodiment the composite material comprises a graphene material as disclosed in WO 2019/054931, such as graphene composites comprising lithium bis(salicylate) borate. WO 2019/054931 is hereby incorporated by reference in its entirety.

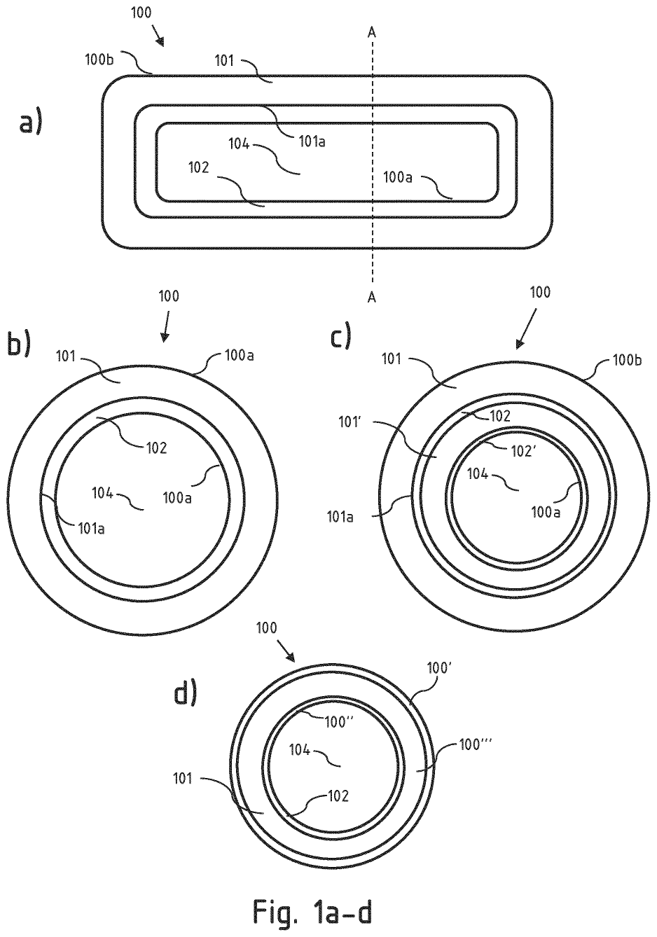

In FIG. 1 there is shown an assembly 100 comprising a hollow body 101 and at least one hydrogen barrier lining 102. The at least one hydrogen barrier lining 102 may be at least one hydrogen gas barrier lining 102. The hydrogen barrier layer 102 comprises a polymer-based composite material 200, comprising a polyethylene-based polymer matrix 202 and reduced graphene oxide 201 in an amount of 0.1-15% in weight per weight of the polymer matrix 202. In the polymer-based composite material 200, the reduced graphene oxide 201 may be distributed or dispersed in the polymer matrix 202.

A ‘lining’ 102 refers to a thin layer or coating provided on the surface of the hollow body 101. The lining 102 may have a thickness in the μm-cm range, for instance 0.1 μm-1 cm. The hollow body 101 may have a thickness in the cm range, for instance 0.5-10 cm. The lining 102 can either bond directly to the mechanically hollow body 101, or an adhesive layer can be provided in between the hollow body 101 and the lining 102. The liner or lining may be provided on the inner surface 101a of the hollow body 100.

In some embodiments the adhesive layer may additionally comprise rGO, in such embodiments the rGO may provide advantageous properties to the adhesive such as for example increased mechanical strength.

One way of providing the liner or lining in or on the hollow body is by co-manufacturing techniques, such as co-extrusion. Another way of providing the liner or lining is by separately manufacturing the hollow body and the lining, and then providing the lining inside or outside the hollow body.

In FIG. 1a, the assembly 100 is embodied as a hydrogen storage container 100 with closed ends. The assembly 100 may comprise an opening (not shown) for allowing the hydrogen to enter and exit the assembly. This opening may be provided with means for attaching further components such as valves and/or pressure reducers and the like.

FIG. 1a shows a schematic illustration of a hydrogen storage container 100 according to the invention. Such a container 100 can be used to store and/or transport hydrogen. FIG. 1a shows a schematic longitudinal cross-section of a hydrogen storage container 100. As can be seen the hydrogen storage container 100 is composed of a hollow body 101, for example a hollow stainless-steel body that is provided with a hydrogen barrier lining 102. FIG. 1b shows a cross-section along A-A of the hydrogen storage container 100 illustrated in FIG. 1a.

The hydrogen storage container 100 may comprise more than one gas barrier lining 102 and/or more than one hollow body 101. A hydrogen storage container 100 can for example have two hollow bodies 101 and 101′, each provided with a hydrogen barrier lining 102 and 102′ as illustrated in FIG. 1c.

The hydrogen storage container 100 has an inner surface 100a and an outer surface 100b. The hollow body 101 has an inner surface 101a. The lining 102 is typically provided at the inner surface 101a of the hollow body as illustrated in FIGS. 1 a-c. As such during use of a hydrogen storage container 100 the lining 102 is in direct contact with the hydrogen when present in the inside space 104 within the container 100. In the examples of assemblies 100 illustrated in FIG. 1 a-c the outer surface 100b is the outer surface of the hollow body 101.

The cross sections of FIGS. 1b, 1c and 1d can alternatively be schematic cross sections of a hydrogen transport pipe or pipe joint. The present patent disclosure concerns improving the hydrogen permeability properties of hydrogen carrying assemblies and/or hydrogen storage and/or transport assemblies by applying the polymer-based composite material as a hydrogen barrier lining 102.

Other examples of assemblies 100 includes three layers: an outer layer 100′, an inner layer 100″, and an intermediate layer 100′″. Such an example is illustrated in FIG. 1d. The assembly, in FIG. 1d embodied as hydrogen storage container 100, comprises an inner layer 100″ being a hydrogen barrier lining 102, an intermediate layer 100′″ being a hollow body 101, and an outer layer 100′. The outer layer 100′ may be an additional hollow body, a layer or a lining that provides another function to the hydrogen storage container 100. For instancing, the additional hollow body, layer or lining may provide improved corrosion resistance to the hollow body 101 when it is to be used in corrosive conditions, such as in sea water.

The hydrogen barrier lining 102 in all embodiments disclosed herein comprises a polymer-based composite material 200 that comprises reduced graphene oxide (rGO) 201 in a polymer matrix 202. The polymer-based composite material 200 may also be referred to as polymer-graphene composite material. The polymer-graphene composite material 200 will be discussed in more detail below.

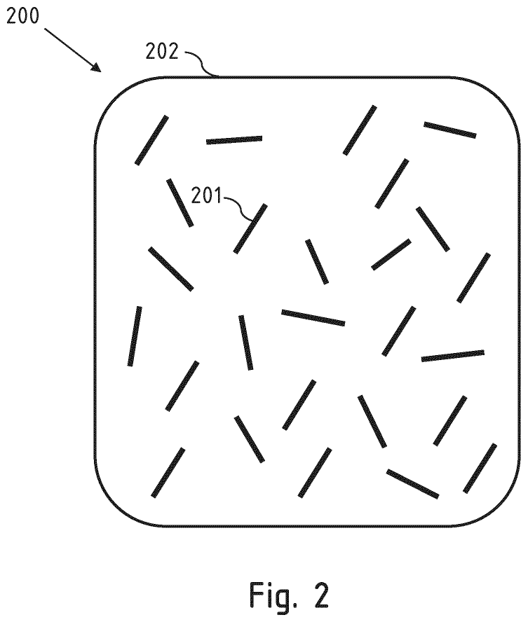

The polymer-graphene composite material 200 is schematically illustrated in FIG. 2. As can be seen in the Figure the rGO 201 is homogeneously or almost homogenously distributed throughout the polymer matrix 202. Without being bound by any theory, it is believed that the homogenous distribution of graphene 201 in the polymer matrix 202 is beneficial in terms of gas permeability. In other words, a lower gas permeation can be achieved for a polymer-graphene composite material 200 wherein the rGO 201 is distributed throughout the polymer matrix 202 as compared to a polymer-based composite material wherein the rGO is more lumped together in parts of the composite material while less present in other parts of the composite material.

The polymer matrix 202 is made of a type of polyethylene (PE). Polyethylene (PE) is a group of polymers that are widely used. It accounts for over a quarter of the world's total plastic market. Most types of polyethylene have the general chemical formula (C₂H₄)ₙ. Examples of polyethylene include high-density polyethylene (HDPE), low-density polyethylene (LDPE), and polyethylene terephthalate (PET). It can be processed using standard manufacturing techniques such as extrusion, blow moulding, rotational moulding, and injection moulding. In one embodiment the polymer-graphene composite material 200 comprises HDPE.

One advantage of the assembly 100 is that less hydrogen leaks out from the assembly 100 compared to if no hydrogen barrier lining 102 is present. Additional improved properties of an assembly 100 according to the present patent disclosure can be increased conductivity and reduced electrostatic effects.

The hydrogen storage container 100 typically is configured to withstand both a wide range of temperatures and high pressure. For instance, in hydrogen transport, the hydrogen may be transported at pressures ranging from 1 bar to 100 bar, for instance 10-90 bar. In a hydrogen gas container, such as a hydrogen gas bottle, the hydrogen pressure may be up to 200 or 300 bar. Hence, the associated assemblies will be subjected to substantial mechanical load. The hollow body 101 may be configured to withstand pressures within these ranges.

As discussed earlier, the assembly 100 as discussed herein can be any type of container that is used to store and/or transport hydrogen in liquid and/or gaseous, pressurized gaseous form. Examples includes tanks, vessels, pipes, joints, cylinders, cartridges, etc.

The hydrogen gas barrier layer or lining 102 comprises the polymer-based composite material 200. As discussed, the polymer-graphene composite material 200 comprises rGO 201 distributed in a polymer matrix 202. The amount of rGO in a polymer-graphene composite material 200 is 0.1-15% in weight per weight of the polymer, 0.5-9% in weight per weight of the polymer, 0.5-5.5% in weight per weight of the polymer, 2.5-5% in weight per weight of the polymer, 3.8-5.5% in weight per weight of the polymer, or 3-5% in weight per weight of the polymer. The rGO can comprise graphene from any type of graphene source. The rGO may comprise 0.1-50 wt % of oxygen.

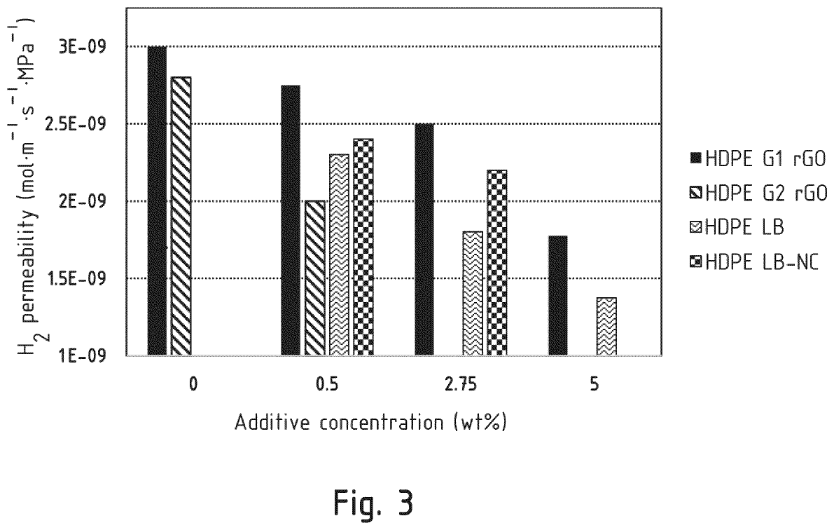

The purpose of a hydrogen barrier lining 102 is to prevent or reduce the permeability of hydrogen through the walls of the assembly 100. FIG. 3 shows measured hydrogen gas permeabilities of different polymer-based composites according to the present patent disclosure versus the amount of additive in wt % added to the polymer matrix. In FIG. 3, results for several graphene-polymer composite materials 200 are shown, each comprising high density polyethylene (HDPE) and reduced graphene oxide (rGO). All samples were manufactured using twin screw extrusion and had the same thickness.

Samples with a first type polymer-based composite material shown in FIG. 3 were manufactured using a first grade of HDPE suitable for extruding. These samples are indicated with by “G1”. The first grade of HDPE had a melt flow rate of about 0.5 g/10 min as measured according to ISO 1133 with a weight of 2.16 kg and at 190° C. Samples with a second type of polymer-based composite material were manufactured using a second grade of HDPE, suitable for injection moulding. These samples are indicated with “G2”. The second grade of HDPE had a melt flow rate of about 2.0 g/10 min as measured according to ISO 1133 with a weight of 2.16 kg and at 190° C. FIG. 3 further shows the gas permeability for polymer-based composite materials comprising high density polyethylene (HDPE) and reduced graphene oxide comprising lithium bis(salicylate) borate (LB), indicated as “HDPE LB”, and a mixture of reduced graphene oxide comprising lithium bis(salicylate) borate and nanoclays (NC), which is indicated as “HDPE LB-NC”. In both these cases, the second grade of HDPE was used. The additive concentration indicates the total wt % of additive added to the HDPE polymer matrix.

As can be seen in the figure, all polymer-based composite materials comprising a graphene additive, i.e. rGO, NC, or rGO comprising lithium bis(salicylate) borate exhibit a lower H₂-gas permeability compared to the bare HDPE polymer samples with 0 wt % additive concentration. Although samples with the G2 grade HDPE appear to perform better than the samples with the G1 grade HDPE, all samples show an improved hydrogen permeability when the additives are included, irrespective of what HDPE is used. The higher the concentration of additive the lower the H₂ gas permeability for all composite materials. The best performing composite materials in terms of hydrogen permeability are the HDPE G2 rGO and HDPE LB samples. The HDPE LB-NC sample is performing similar to or better than the HDPE G1 rGO sample.

However, increasing the amount of rGO additive too much is no longer beneficial since it will have reduce the processibility of the polymer-based composite material. For example, the higher the rGO concentration, the higher the polymer viscosity and, hence, the more difficult to processes. Furthermore, increasing the graphene concentration in polymer composites is known to reduce the flexibility of the polymer. A large amount, more than 15% in weight per weight of the polymer, of graphene additive results in a material that is not possible or very difficult to process in standard techniques such as injection moulding, blow moulding and extrusion.

As mentioned above the rGO in a composite material 200 according to the present patent disclosure may be any type of rGO, or any type of graphene that has been first oxidized and then reduced to form rGO. rGO is a form of graphene oxide (GO) that is processed in order to reduce the oxygen content. The processing can be by chemical, thermal, or other methods known to persons skilled in the art.

In one embodiment the polymer-based composite material 200 comprises a mixture of nanoclay and graphene. Nanoclays may comprise or be layered mineral silicates. The nanoclay may comprise, or consist of, layered mineral silicate-based nanoparticles. There are several types of nanoclays that are classified depending on chemical composition and morphology: montmorillonite, bentonite, kaolinite, hectorite, and halloysite. In one embodiment of the present patent disclosure the polymer-based composite material comprises a mixture of nanoclay and reduced graphene oxide as additives. The amount in terms of weight of nanoclay and reduced graphene oxide may be equal, or almost equal. Herein the term ‘equal’ refers to a difference of 10% or less.

In one embodiment of the invention the rGO comprises a salt, the salt may be intercalated in between the graphene layers. The salt may comprise Na⁺ or Li⁺. The salt may further comprise Al or B as anion. In one embodiment the salt comprises or is lithium bis(salicylate) borate (Li[BScB]).

The rGO in the composite material 200 may further comprise Li⁺ and/or Na⁺. This is beneficial in terms of reduced hydrogen permeability, as is clear from FIG. 3 from the samples including “LB”. Without being bound by any theory, Li⁺ and/or Na⁺ have a high capacity as a hydrogen storage material wherein hydrogen can be reversible stored at the material. Additionally, pristine graphene and reduced graphene oxide are also able to reversibly store hydrogen. The combination of reduced graphene oxide and Li⁺ and/or Na⁺, a highly hydrogen impermeable composite material is obtained. This can be seen in the data of FIG. 3. As for all types of additives used in the present patent disclosure, also in this case the hydrogen gas permeability value decreases with an increased concentration of additive. The composite material with the lowest measured hydrogen permeability is the composite material comprising rGO and lithium bis(salicylate) borate (“HDPE LB”).

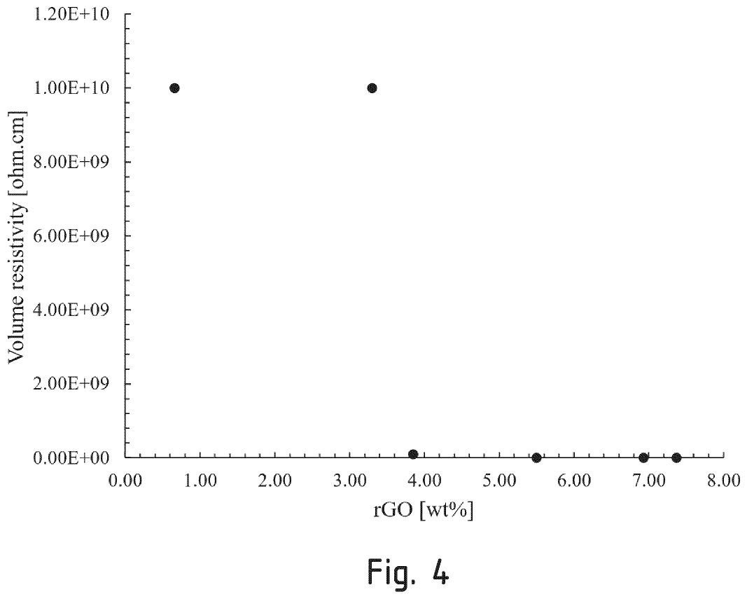

Another benefit of the hydrogen barrier lining 102 is that it may have a low volume or electrical resistivity. This resistivity is a material property that measures how well a material resists electrical current, the unit for volume resistivity is ohm centimetre [Ω·cm] or ohm meter [Ω·m]. FIG. 4 shows the volume resistivity as a function of rGO content in wt % in a polymer-based composite material 200 according to the present patent disclosure. As can be seen in the Figure an increasing amount of rGO result in a decreasing resistivity. The resistivity decreases rapidly to a value that is close to 0 between an addition of 3 wt % and 4 wt % rGO, more specifically between 3.3 wt % and 3.8 wt %.

A hydrogen barrier lining 102 can typically be provided in the assembly by providing the hollow body, for example a stainless-steel tank, a carbon fibre winded tank, a stainless-steel pipe, a polymer pipe, etc., with an inner lining of the graphene-based composite material 200. The lining can be made using for example extrusion, injection moulding, rotational moulding, blow moulding or spray coating.

Extrusion of polymers is a processing technique wherein the polymer is melted and formed into a desired profile. The polymer is melted by heaters and by mechanical energy generated by screws used in the process. The polymer-graphene composite material 101 can be manufactured by mixing a polymer with rGO using for example an extruder.

In one aspect of the present patent disclosure there is provided a method for manufacturing an assembly for carrying hydrogen or an assembly for hydrogen storage and/or transport, wherein an inner surface 101a of a hydrogen storage container 100 is lined with, or coated with, the hydrogen barrier lining 102. Typically, the assembly 100 is manufactured by coating an inner surface of a hollow body with the polymer-based composite material 200. The polymer-based composite material 200 can be manufactured by mixing a polymer with at least rGO, using for example an extruder.

### Experimental

For all sample preparations HDPE was used as the polyethylene-based polymer. These samples thus contained a HDPE-based polymer matrix.

### Gas Permeability Testing

Four different samples were prepared, as mentioned above for FIG. 3. Further details are described below. For the LB-NC samples a 50/50 ratio in terms of weight of LB/NC was used.

Preparation of Samples with rGO as Additive

A batch of HDPE comprising 11 weight % of rGO was first prepared. Thereafter, this batch was diluted to concentrations of 0.5, 0.66, 2.75, 3.0, 3.3, 3.85, 5.0, 5.5, 6.93, and 7.4 weight % through mixing with more HDPE.

### Mixed Samples Including the HDPE LB and LB-NC Samples

The mixed samples were prepared using the 11 weight % rGO batch. This 11 wt % batch was diluted and then extruded to the desired concentrations of additive including rGO and LB and optionally NC. The extrusion was performed using standard process parameters. The samples referred to as LB comprising Li-salt comprised 10 wt % of lithium bis(salicylate) borate relative to rGO.

Table 1 below shows an overview of all samples prepared for the gas permeability tests.

TABLE 1
Overview of first set of samples.

| Sample name | Additive concentration [wt %] | | | | | | | | | | |
|---|---|---|---|---|---|---|---|---|---|---|---|
| HDPE rGO G1 | 0 | 0.50 | 0.66 | 2.75 | | 3.3 | 3.85 | 5.00 | 5.5 | 6.93 | 7.37 |
| HDPE rGO G2 | 0 | 0.50 | | | 3.00 | | | | | | |
| HDPE LB | | 0.50 | | 2.75 | | | | 5.00 | | | |
| HDPE LB-NC | | 0.50 | | 2.75 | | | | | | | |

### Gas Permeability Testing

The gas permeability was tested according to the ASTM D3985-17 method. The permeability curves were obtained by placing them in a circular permeation cell. A porous stainless-steel plate was applied to support the sample during the high-pressure conditions. The area of the stainless-steel plate was 19.6 cm², which area was used for the permeability calculations as the effective area available for permeation. The sealing between the feed and permeate side was obtained by an O-ring that was placed between the sample and the feed side of the module. An additional sealing ring, placed on the permeate side of the module, was used to prevent leakages towards the external environment.

Permeation measurements were conducted using a constant-pressure method, analogue to ASTM D3985-17. The set-up was designed to withstand a pressure up to 30 bar. The permeation cell was placed in a Memmert UF450 forced air circulation oven for temperature control.

The permeation experiments were performed as follows:
1. Seal sample in cell and connect it to the setup.
2. Heat the setup to the operating temperature (50° C.) and exposing to small overpressure of N₂ (1 bar).
3. At a stable temperature/pressure and gas chromatography analysis, N₂ is replaced with H₂, while the pressure is rapidly increased to 20 bar. H₂ gradually permeates through the sample, and the breakthrough is determined by gas chromatography. The permeation is left to stabilize to obtain the permeate rate at a temperature of 50° C.

### Results Gas Permeability Testing

FIG. 3 shows a permeability graph wherein H₂ permeability is measured for the first set of samples comprising HDPE and rGO, HDPE and a mixture of rGO comprising lithium bis(salicylate) borate and nanoclay ( . . . ), and HDPE and rGO comprising lithium bis(salicylate) borate. As can be seen for all samples a decreased permeability can be seen with increasing concentrations of reduced graphene oxide. What can also be seen is that the materials comprising lithium bis(salicylate) borate show the lowest gas permeability for H₂.

The lowest gas permeability of the three samples is shown by the material comprising graphene and lithium bis(salicylate) borate and no nanoclays.

### Resistivity Testing

Six samples were tested for resistivity: HDPE comprising 0.66, 3.3, 3.85, 5.5, 6.93, and 7.37 wt % rGO. The electrical resistivity was derived through a series of measurements and calculations on respective filaments produced with extrusion. First, a linear relationship between the measured resistance and the resistivity value was established by measuring the resistance up to 1 m, using 10 cm intervals, and then deriving the resistivity value by calculating the gradient of the resistance vs length plot. Linearity was established, so the resistivity values were calculated for 10 cm length filaments. For the contact areas between the filament and the probe (Electron Microscopy Sciences, USA), silver colloidal paste was used for the contact areas between the filament and the probe. The resistance was measured using a four probe micro-ohmmeter. The results from the resistivity testing are shown in FIG. 4. The results have been discussed above.

### Second Set of Samples

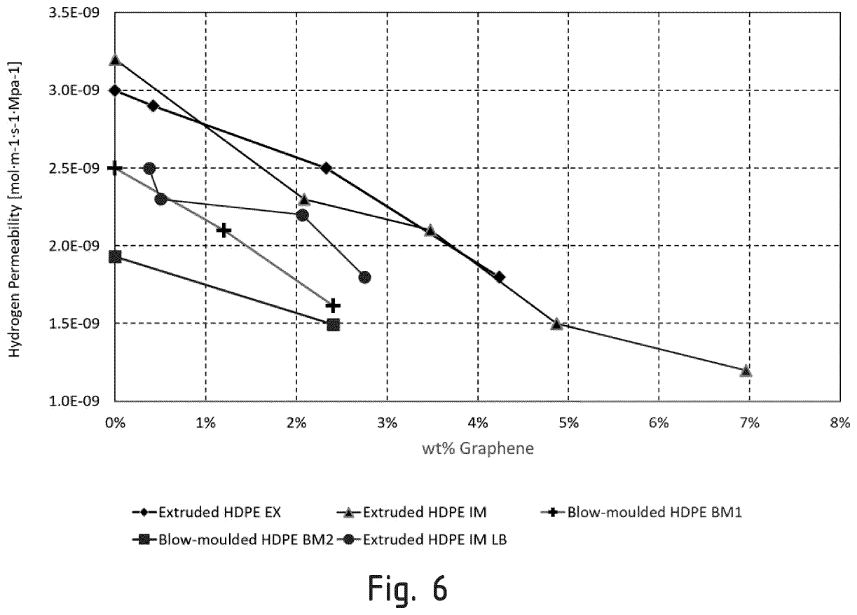

FIG. 6 shows further hydrogen permeability results for a second set of samples. Unless mentioned otherwise, the preparation of and measurements on these samples were the same as described above. The polymer-based composite material samples were processed in a 24-mm twin screw extruder where the graphene was fed through a side feeder to be mixed with neat polyethylene grade.

The compounding process was conducted in two steps, the first step was to prepare a masterbatch with a high amount of rGO, namely about 8 wt % relative to the total weight of the polymer-based composite. In the second step pellets of masterbatch and neat polyethylene were mixed and then the mixture was extruded to obtain the polymer-based composite material with the given graphene concentrations. The samples of the data shown in FIG. 6 were based on an extrusion HDPE grade denoted as HDPE EX (Dowlex 2388, an HDPE grade for extrusion made by Dow), an injection moulding HDPE grade denoted as HDPE IM (Lupolen 5038GX, an HDPE grade for injection moulding made by LyondellBasell), the same injection moulding HDPE grade with the Li-salt added denoted as HDPE IM LB, and two HDPE blow moulding grades denoted as BM1 (Lupolen 4261AG, a blow moulding HDPE grade made by LyondellBasell) and BM2 (SABIC5411, a blow moulding grade made by Sabic) respectively. For all sample types, a neat sample without graphene was made, as well as samples with varying amounts of graphene, as can be seen, for example, in FIG. 6.

The blow moulding samples were prepared by blending pellets of HDPE EX with pellets of the denoted blow moulding grade to obtain the given respective rGO concentrations. The mixture of pellets was then treated with a blow moulding process known in the art, for example including heating of the mixture of pellets and feeding the heated mixture to the blow moulding equipment to form a parison, clamping the parison into a mould and blowing pressurized air, or any other gas, into the parison such that the parison conforms to the mould. Two different sizes of blow-moulded liners were prepared, 10 L and 52 L. An industrial blow-moulding equipment ST ASTI 200 was used. The used conditions included a pressure of 20 bar and a temperature of 50° C.

### Blow Moulding Tests 1

Three sets of liners were prepared based on BM1, including a BM1 reference without rGO, and BM1 with 15 wt % and 30 wt % HDPE EX masterbatch, resulting respectively in rGO concentrations of 1.2 wt % and 2.4 wt % with respect to the total weight of the polymer composite material. The hydrogen permeability and mechanical properties of the produced liners were evaluated.

During the blow moulding, it was noted that, beneficially, the Parison drop time (PDT) was slightly longer because of the higher swelling ratio. The parison strength was not impacted using extrusion grade masterbatch and stayed in the standard range for polyolefin grades.

The produced liners had a mat and uniform appearance in line with the usual standards for industrial parts. No appearance of defects either on inside or outside the liners was found.

### Blow Moulding Tests 2

Two sets of liners were prepared based upon BM2, including a BM2 reference without rGO and BM2 with 30 wt % HDPE EX masterbatch, resulting in a rGO concentration of 2.4 wt % with respect to the total weight of the polymer composite material. The hydrogen permeability and mechanical properties of the produced liners were evaluated.

### Melt Flow Rate

The melt flow properties of dilutions of a HDPE EX masterbatch with total rGO content 10.4±0.4 wt % with respect to the total weight of the polymer composite material with neat HDPE EX were determined using a Tinius Olsen MP 1200 according to ISO 1183-1:2019 Proc B. The testing was performed according to ISO 1183-1:2019 Proc. B. The testing was performed on the samples as received with 2.16 kg load at 190° C.

The melt flow rate (MFR), melt volume rate (MVR) and melt density for neat HDPE EX and 5-30 wt % dilutions of the specified HDPE EX masterbatch are given in Table 2.

It can be observed from Table 2 that addition of HDPE EX masterbatch to neat HDPE EX lowers the melt flow rate. This is beneficial in the blow-moulding process as the parison stiffness will increase, leading to an increase in Parison drop time (PDT).

TABLE 2
The melt flow rate (MFR), melt volume rate (MVR) and melt density
for neat HDPE EX and 5-30 wt % dilutions of a HDPE EX masterbatch
comprising 10.4 ± 0.4 wt % rGO with respect to the total
weight of the polymer composite material with neat HDPE EX.

| | wt % | MFR [g/10 | MVR [cm³/10 | Melt Density |
|---|---|---|---|---|
| Sample | MB | min] | min] | [g/cm3] |
| Neat HDPE EX | 0 | 0.54 | 0.73 | 0.74 |
| HDPE EX 5% MB | 5 | 0.49 | 0.63 | 0.77 |
| HDPE EX 10% MB | 10 | 0.40 | 0.53 | 0.77 |
| HDPE EX 15% MB | 15 | 0.34 | 0.44 | 0.77 |
| HDPE EX 20% MB | 20 | 0.28 | 0.37 | 0.77 |
| HDPE EX 30% MB | 30 | 0.15 | 0.19 | 0.78 |

### Results Gas Permeability Testing

Measurements of hydrogen permeability through the neat and reduced graphene oxide containing HDPE materials were done at 20 bar and 50° C. Permeation experiments were conducted in a permeation set-up along standard ASTM D1434-82 (manometric, procedure M). Prior to the testing all samples were degassed in a vacuum furnace at 60° C. at 5 mbar for a minimum of 2 days. Testing proceeded for 1 day per sample, and was performed as follows:

Installation of the sample in cell. Application of vacuum overnight at the desired temperature (50° C.) to allow for an additional degassing of the sample. Subsequently, a vacuum test is performed for approximately 1 h to assure a sufficiently low degassing rate as this will otherwise incorrectly be assessed as permeating species. Subsequently the upstream side of the sample is exposed to hydrogen at approximately 20 bars, and the downstream side is monitored until the achievement of steady-state conditions. The test provides direct measurement of permeability (stable permeation) and diffusivity (via the breakthrough/permeation curve). The solubility coefficient can then be calculated according to the solution/diffusion mechanism principle. Variation of sample thickness is taken into account in the calculations.

As can be seen in FIG. 6, all samples show reduced hydrogen permeability compared to their respective neat references without graphene (at 0 wt %). The blow-moulded samples showed the lowest hydrogen permeability of all samples, including when comparing the neat samples without rGO. A reduction of 14% in hydrogen permeability is measured for the BM1 sample with 1.2 wt % rGO relative to the total weight of the polymer composite material. A reduction of 35% in hydrogen permeability is obtained for the BM1 sample with 2.4 wt % rGO relative to the total weight of the polymer composite material.

The highest reductions in hydrogen permeability for extruded HDPE EX is 47% (at 4.2 wt % rGO=and for extruded HDPE IM it is 63% (at 7% rGO).

The extruded sample HDPE IM LB showed the lowest hydrogen permeability for all extruded samples, thus showing the beneficial effect of the Li-salt on the hydrogen permeability.

Furthermore, it can be observed from FIG. 6, that the extruded HDPE IM grade with highest rGO content (7.0% in weight per total weight of the polymer composite material has a hydrogen permeation of 1.2E-9 mol·m⁻¹·s⁻¹·MPa⁻¹ or 6.6E-18 m³·m/m². Pa·s or 6.0E-14 kg/m·s·Bar. This near the measured hydrogen permeability of literature value for polyamide of 2.6-3.2E-10 mol·m⁻¹·s⁻¹·MPa⁻¹ or 1.4-1.8E-18 m³·m/m²·Pa·s or 1.3-1.6E-14 kg/m·s·Bar (Dennis Krieg, Konzept und Kosten eines Pipelinesystems zur Versorgung des deutschen Straßenverkehrs mit Wasserstoff, Dissertation thesis 2012, Forschungszentrum Jülich GmbH Zentralbibliothek, Verlag Jülich ISBN: 978-3-89336-800-6). Thus, beneficially, the hydrogen permeability of HDPE grades can be reduced close to the level of polyamide grades by use of HDPE with rGO as shown in the present patent disclosure. This is especially advantageous as HDPE is known to be processed in a more straight forward manner than PA, such a PA6. Also, the composite polymer materials according to the present patent application may be used in higher pressure applications such as those that PA is used for currently, i.e. up to 700 bars hydrogen pressure.

### Mechanical Properties

Tensile Properties of the extruded pellets were determined using a Tinius Olsen H10ST according to ISO 527:2019. Test plates of roughly 4 mm thickness were produced using a Fontijne LabEcon press using a flash mould with 5 MPa moulding pressure under 180 degrees. From these, tensile test pieces were punched using a Elastocon Pneumatic cutting press EP 02. The test pieces were subjected to thermal conditioning for 3 h at 23° C. before testing.

To prepare dog bones from the blow-moulded parts, some of the parisons were cut in half and stretched out just after blow-moulding. Dog bones were milled out in the vertical and lateral direction from flattened blow-molded cylinders of neat HDPE and HDPE with rGO. The dog bones were subjected to thermal conditioning for 3 h at 23° C. before testing. Tensile properties of the dog bones were determined according to ISO 527:2019 using a Tinius Olsen H10ST.

The results are presented in Table 3 below.

TABLE 3
Mechanical properties measured for various BM1
based samples of the second set of samples

| | Tensile | Ultimate | Elongation at |
|---|---|---|---|
| | modulus | strength | break |
| Material | (MPa) | (MPa) | (MPa) |
| Nead BM1 TDS data | 900 | 24 | — |
| Neat BM1 #1 | 827 ± 243 | 17.4 ± 0.9 | 549 ± 63 |
| Neat BM1 #2 | 969 ± 374 | 17.7 ± 0.6 | 373 ± 222 |
| BM1 w/15% HDPE EX MB | 1140 ± 63 | 22.3 ± 0.3 | 494 ± 120 |
| Longitudinal | | | |
| BM1 w/15% HDPE EX MB | 951 ± 159 | 21,.4 ± 1.0 | 326 ± 79 |
| Lateral | | | |
| BM1 w/30% HDPE EX MB | 882 ± 17 | 20.1 ± 0.1 | 521 ± 54 |
| Longitudinal | | | |
| BM1 w/30% HDPE EX MB | 895 ± 95 | 20.2 ± 0.2 | 527 ± 51 |
| Lateral | | | |

The masterbatch comprised 8 wt % rGO, so the samples with 15% MB comprised 1.2 wt % rGO and the samples with 30% MB comprised 2.4 wt % rGO relative to the total weight of the polymer composite material. The measurements were done in two directions, longitudinal and lateral, since blow moulded parts of these grades may be anisotropic. The longitudinal direction is the direction parallel to the longest dimension of the blow moulded part, and the lateral direction is the direction perpendicular to the longitudinal direction. As is apparent from Table 2, the samples with graphene had comparable tensile moduli to pure resin. Also, the samples with graphene showed increased ultimate strength by 14-28%, while the elongation at break is comparable to neat BM1. Also, the samples show less difference between the two directions (longitudinal and lateral) so the anisotropy is decreased, which is beneficial for parts, especially when used to contain pressurized fluids as in the present patent disclosure.

### Hydrogen Carriers

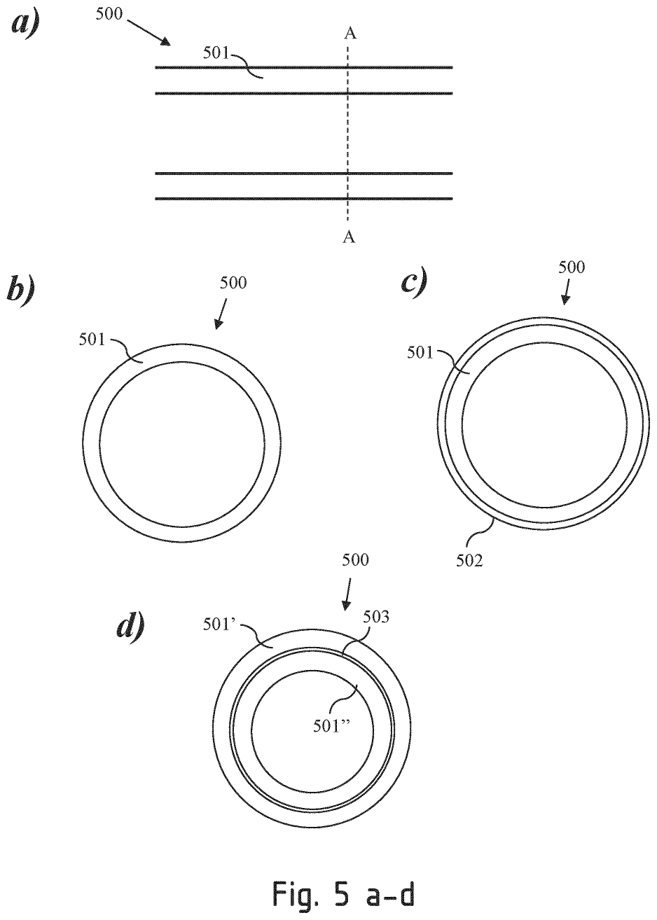

Referring now to FIG. 5, there is shown a hydrogen carrier 500 according to the present patent disclosure comprises a hollow body that is able to withstand mechanical stress and hence provides load bearing support to the hydrogen carrier 500. The hollow body may, for instance, have a thickness in the cm size range and is as such typically a main part of the hydrogen carrier 100, or one of the main parts.

There is provided a hydrogen carrier 500 for hydrogen storage and/or transport. The hydrogen carrier 500 comprises a hollow body 501 comprising or consisting of a polymer-based graphene composite material 200. The polymer-based composite material 200 comprises a polyethylene-based polymer matrix 202 and reduced graphene oxide 201 in an amount of 0.1%-15% in weight per weight of the polyethylene-based polymer matrix 202.

In the polymer-based composite material 200 the reduced graphene oxide 201 may be distributed in the polymer matrix 202. The polymer-based composite material 200 may also be referred to as the polymer-graphene composite material 200.

FIG. 5a shows a schematic illustration of a hydrogen storage container 500, an embodiment of the hydrogen carrier, according to the present patent disclosure. Such a container 500 can be used to store and/or transport hydrogen. FIG. 5a shows a schematic longitudinal cross-section of a hydrogen storage container 500 that is open-ended, e.g. in the form of a tube or pipe. FIG. 5b shows a cross-section along A-A of the hydrogen storage container 500 illustrated in FIG. 5a.

In certain embodiments, the hydrogen carrier 500 may have more parts or layers such as an additional outer or inner layer that is separate from the hollow body 501. In the hydrogen carrier 500 at least the hollow body 501 comprises the polymer-graphene composite material 501. As will be discussed in more detail further down, the hollow body 501 may for example be formed by extrusion.

As mentioned, the hydrogen carrier 500 may comprise other parts, for example, but not limited to, additional cross-sectional portions as schematically illustrated in FIGS. 5c and d. In FIG. 5c an outer portion 502, or second hollow body 502 arranged concentrically with the hollow body 501, is provided for providing increased mechanical stability or impact protection, for example. Such an outer portion 502 may comprise or consist of a carbon fiber polymer composite or steel. Similar portions as the outer portion 502 may be provided on the inside of the hollow body 501.

A further alternative is that reinforcements are provided in the polymer-graphene composite material 200, for example the polymer-graphene composite material may further comprise carbon fibers. A yet further alternative is illustrated in FIG. 5d, wherein the hydrogen carrier comprises from outside towards inside: have a first hollow body 501′, a hollow mechanical reinforcement body 503, and a second hollow body arranged within the mechanical reinforcement body 503. At least one of the first hollow body 501′ and the second hollow body 501″ comprises or consist of the polymer-graphene composite material 200. The first 501′ and second 501″ hollow bodies may have a thickness in the cm size range and are typically thicker than the hollow mechanical reinforcement body 503 that would, for instance, have a thickness in the mm size range. The mechanical reinforcement body 503 may, for example, be made of stainless-steel, or made by carbon-fiber winding.

The hydrogen carrier 500 beneficially increases the amount of hydrogen that remains in the container 500 and reduces the amount of hydrogen permeating through the hollow body 501. Additional improved properties by a hydrogen carrier 500 according to the invention include increased conductivity, increased load bearing capacity, and reduced electrostatic effects.

As discussed earlier the hydrogen carrier 500 as discussed herein can be any type of container that is used to store and/or transport hydrogen in liquid and/or gaseous form. Examples includes tanks, vessels, pipes, joints, cylinders, cartridges, etc.

The hydrogen carrier 500 typically is configured to withstand both a wide range of temperatures and high pressure. For instance, in hydrogen transport, the hydrogen may be transported at pressures ranging from 1 bar to 100 bar, for instance 2 to 30 bar. Hence, the associated assemblies will be subjected to substantial mechanical load. The hollow body 501 may be configured to withstand pressures within these ranges. Polyethylene based pipelines may be used preferably in the lower range of hydrogen pressures, such as at 2-10 bar or 2-5 bar.

Another benefit of the hydrogen carrier 500 is that it may have a low volume or electrical resistivity, see description of FIG. 4 above.

The hydrogen carrier 500 according to the present patent disclosure can typically be manufactured by standard techniques such as injection moulding, rotational moulding, blow moulding or spray coating. In one aspect there is provided a method for manufacturing a hydrogen carrier 500 according to the present patent disclosure, wherein the hydrogen carrier 500 is manufactured using extrusion or injection moulding.

Extrusion of polymers is a processing technique wherein the polymer is melted and formed into a desired profile. The polymer is melted by heaters and by mechanical energy generated by screws used in the process. The polymer-graphene composite material 200 may be manufactured by mixing a polymer with rGO using for example an extruder.

### Further Embodiments of the Present Disclosure

The disclosure comprises the following embodiments:

1. A polymer-based composite material (200) comprising a polyethylene-based polymer matrix (202) and reduced graphene oxide (201) in an amount of 0.1%-15% in weight per weight of the polyethylene-based polymer matrix (202).

2. The polymer based composite material (200) according to embodiment 1, wherein the reduced graphene oxide (201) is distributed in the polyethylene-based polymer matrix (202).

3. The polymer-based composite material (200) according to embodiment 1 or 2, comprising reduced graphene oxide (201) in an amount of 0.5%-9% in weight per weight of the polyethylene-based polymer matrix (202).

4. The polymer-based composite material (200) according to embodiment 1, 2 or 3, wherein the amount of reduced graphene oxide (201) in the polymer-based composite material (200) is 0.5%-5% in weight per weight of the polyethylene-based polymer matrix (202).

5. The polymer-based composite material (200) according to any one of the preceding embodiments, wherein the amount of reduced graphene oxide (201) in the polymer-based composite material (200) is 2.5%-5% in weight per weight of the polyethylene-based polymer matrix (202), preferably 3%-5% in weight per weight of the polyethylene-based polymer matrix (202).

6. The polymer-based composite material (200) according to any one of the proceeding embodiments, wherein the polymer-based composite material further comprises nanoclay.

7. The polymer-graphene composite material (200) according to embodiment 6, wherein the polymer-based composite material comprises the nanoclay in an amount equal to 90 to 110 wt % per weight of reduced graphene oxide.

8. The polymer-graphene composite material (200) according to embodiment 6 or 7, wherein the nanoclay comprises layered mineral silicate-based nanoparticles.

9. The polymer-graphene composite material (200) according to embodiment 8, wherein the layered mineral silicate-based nanoparticles comprise one or more selected from the group consisting of montmorillonite nanoparticles, bentonite nanoparticles, kaolinite nanoparticles, hectorite nanoparticles, halloysite nanoparticles.

10. The polymer-based composite material (200) according to any one of the proceeding embodiments, wherein the reduced graphene oxide (201) in the polymer-based composite material (200) comprises a Li-salt, preferably lithium bis(salicylate) borate; and/or wherein the polyethylene-based polymer matrix comprises a mixture of extrusion grade high density polyethylene and blow moulding grade high density polyethylene.

11. Assembly (100) for hydrogen storage and/or transport, the assembly comprising:
a hollow body (101); and
at least one hydrogen barrier lining (102) arranged along a surface of the hollow body (101);
   wherein the at least one hydrogen barrier lining (102) comprises a polymer-based composite material (200) according to any one of the previous embodiments.

12. Assembly (100) according to embodiment 11, wherein the surface of the hollow body is an inner surface (101a) of the hollow body (101).

13. Assembly (100) according to embodiment 11 or 12, wherein the body is a tank, a vessel, a pipe, a joint, or a cylinder.

14. Assembly (100) according to embodiment 11, 12 or 13, wherein the assembly is a hydrogen storage container or a hydrogen transport container,
wherein preferably the hydrogen storage container is a hydrogen storage tank, a hydrogen storage vessel, or a hydrogen cylinder wherein optionally the hydrogen cylinder is a hydrogen gas cylinder; and/or the hydrogen transport container is a hydrogen transport pipe or a joint for joining hydrogen transport pipes.

15. Assembly (100) according to any one of embodiments 11 to 14, wherein the hollow body (101) is a hollow stainless-steel body, a hollow carbon fibre winded body, or a hollow polymer body.

16. Assembly (100) according to any one of embodiments 11 to 15, wherein the hydrogen barrier lining (102) is attached to the hollow body (101) using an adhesive.

17. Assembly (100) according to any one of embodiments 11 to 15, wherein the hydrogen barrier lining (102) is attached to the hollow body in a binder-free manner.

18. A method for manufacturing an assembly for hydrogen storage and/or transport (100) according to any one of embodiments 11 to 17, comprising lining a surface (101a) of the hollow body (101) with one of the at least one hydrogen barrier linings (102).

19. Use of a polymer-graphene composite material (200) according to any one of embodiments 1-10 as a hydrogen barrier lining (102).

20. Hydrogen carrier (500) for hydrogen storage and/or transport, the hydrogen carrier comprising a hollow body (501) comprising a polymer-based graphene composite material (200) according to any one of embodiments 1 to 10.

21. Hydrogen carrier (500) according to embodiment 20, wherein the hollow body is a tank, a vessel, a pipe, a joint, or a cylinder.

22. Hydrogen carrier (500) according to embodiment 20 or 21, wherein the hydrogen carrier is a hydrogen storage container or a hydrogen transport carrier, wherein preferably the hydrogen storage container is a hydrogen storage tank, a hydrogen storage vessel, or a hydrogen cylinder wherein optionally the hydrogen cylinder is a hydrogen gas cylinder; and/or the hydrogen transport carrier is a hydrogen transport pipe or a joint for joining hydrogen transport pipes.

23. Hydrogen carrier (500) according to embodiment 20, 21 or 22, wherein the hollow body (501) is made of the polymer-based graphene composite material (200).

24. Hydrogen carrier (500) according to any one of embodiments 20 to 23, wherein the hollow body (501) is a first hollow body (501′, 501″); and
the hydrogen carrier further comprises a second hollow body (501′, 501″) concentrically arranged relative to the first hollow body (501′, 501″).

25. Hydrogen carrier (500) according to embodiment 24, further comprising a hollow mechanical reinforcement body (503) arranged in between the first hollow body (501′, 501″) and the second hollow body (501′, 501″)

26. Hydrogen carrier (500) according to embodiment 24 or 25, wherein the second hollow body (501′, 501″) is made of the polymer-based composite material (200).

27. Hydrogen carrier (500) according to embodiment 24, 25 or 26, wherein the second hollow body (501″) is arranged inside the first hollow body (501′).

28. Hydrogen carrier (500) according to any one of embodiments 24 to 27, wherein the first hollow body (501″) is arranged inside the second hollow body (501′).

29. A method for manufacturing a hydrogen carrier (500) according to any one of embodiments 20 to 28, wherein the hydrogen carrier (500) is manufactured using extrusion or injection moulding.

30. An extruded hydrogen carrier (500) comprising a polymer-graphene composite material (200) according to any one of embodiments 1 to 10.

Although the present invention has been described with reference to specific embodiments, also shown in the appended drawings, it will be apparent to those skilled in the art that many variations and modifications can be done within the scope of the invention as described in the specification and defined with reference to the claims below.

1. A polymer-based composite material comprising a polyethylene-based polymer matrix and reduced graphene oxide in an amount of 1.2%-15% in weight per weight of the polyethylene-based polymer matrix, wherein the polyethylene-based polymer matrix is a high density polyethylene-based polymer matrix.

2. The polymer based composite material according to claim 1, wherein the reduced graphene oxide is distributed in the polyethylene-based polymer matrix.

3. The polymer-based composite material according to claim 1, comprising reduced graphene oxide in an amount of 2%-9% in weight per weight of the polyethylene-based polymer matrix.

4. The polymer-based composite material according to claim 1, wherein the amount of reduced graphene oxide in the polymer-based composite material is 2%-7% in weight per weight of the polyethylene-based polymer matrix.

5. The polymer-based composite material according to claim 1, wherein the amount of reduced graphene oxide in the polymer-based composite material is 2.3%-7% in weight per weight of the polyethylene-based polymer matrix, preferably 2.3%-5% in weight per weight of the polyethylene-based polymer matrix, such as 2.5%-5%, and 3%-5% in weight per weight of the polyethylene-based polymer matrix.

6. The polymer-based composite material according to claim 1, wherein the polymer-based composite material further comprises nanoclay.

7. The polymer-graphene composite material according to claim 6, wherein the polymer-based composite material comprises the nanoclay in an amount equal to 90 to 110 wt % per weight of reduced graphene oxide.

8. The polymer-graphene composite material according to claim 6, wherein the nanoclay comprises layered mineral silicate-based nanoparticles.

9. The polymer-based composite material according to claim 1, wherein the reduced graphene oxide in the polymer-based composite material comprises a Li-salt, preferably lithium bis(salicylate) borate.

10. The polymer-based composite material according to claim 1, wherein the polyethylene-based polymer matrix comprises a mixture of extrusion grade high density polyethylene and blow moulding grade high density polyethylene.

11. An assembly for hydrogen storage and/or transport, the assembly comprising:
a hollow body; and
at least one hydrogen barrier lining arranged along a surface of the hollow body;
wherein the at least one hydrogen barrier lining comprises a polymer-based composite material comprising a polyethylene-based polymer matrix and reduced graphene oxide in an amount of 0.1%-15% in weight per weight of the polyethylene-based polymer matrix.

12. The assembly according to claim 11, wherein the surface of the hollow body is an inner surface of the hollow body.

13. The assembly according to claim 11, wherein the body is a tank, a vessel, a pipe, a joint, or a cylinder.

14. The assembly according to claim 11, wherein the assembly is a hydrogen storage container or a hydrogen transport container,
wherein preferably the hydrogen storage container is a hydrogen storage tank, a hydrogen storage vessel, or a hydrogen cylinder wherein optionally the hydrogen cylinder is a hydrogen gas cylinder; and/or the hydrogen transport container is a hydrogen transport pipe or a joint for joining hydrogen transport pipes.

15. The assembly according to claim 11, wherein the hollow body is a hollow stainless steel body, a hollow carbon fibre winded body, or a hollow polymer body.

16. The assembly according to claim 11, wherein the hydrogen barrier lining is attached to the hollow body using an adhesive.

17. The assembly according to claim 11, wherein the hydrogen barrier lining is attached to the hollow body in a binder-free manner.

18. The assembly according to claim 11, wherein the reduced graphene oxide is in an amount of 1.2%-15% in weight per weight of the polyethylene-based polymer matrix.

19. The assembly according to claim 11, wherein the polyethylene-based polymer matrix is a high density polyethylene-based polymer matrix.

20. The assembly according to claim 11, wherein the hydrogen barrier lining is made by blow moulding.

21. The assembly according to claim 11, wherein the hydrogen barrier lining is made by extrusion, such as co-extrusion.

22. A method for manufacturing an assembly for hydrogen storage and/or transport according to claim 11, comprising lining a surface of the hollow body with one of the at least one hydrogen barrier linings.

23. The method according to claim 22, wherein the at least one hydrogen barrier lining is made by blow moulding.

24. (canceled)
